(19) United States
(12) Patent Application Publication
(10) Pub. No.: US 2020/0092566 A1
(43) Pub. Date: Mar. 19, 2020

(54) METHOD AND SYSTEM FOR DETERMINING A FLOW RATE OF A FUGITIVE FLUID PLUME

(71) Applicant: Power Diagnostic Technologies Ltd., New Westminster (CA)

(72) Inventors: Adekunle Adeyemi, Calgary, AB (CA); Thomas Darcie, Victoria, BC (CA)

(21) Appl. No.: 16/576,662

(22) Filed: Sep. 19, 2019

Related U.S. Application Data
(60) Provisional application No. 62/733,258, filed on Sep. 19, 2018.

(51) Int. Cl. H04N 19/176; G01F 7/00; H04N 19/625

(52) U.S. Cl. CPC H04N 19/176; H04N 19/61; H04N 19/625; G01F 7/00

(57) ABSTRACT

A method of determining a flow rate of a predetermined emissive substance involves: (a) generating a timed sequence of images; (b) partitioning a first image of the timed sequence into a plurality of blocks of pixels; (c) selecting from the plurality of blocks a selected block having calculated therefrom a first set of Discrete Cosine Transform (DCT) coefficients; (d) determining that the first set meets a condition associated with a predetermined threshold such that the first block represents an intensity pattern of the predetermined emissive substance at a first time; (e) selecting a corresponding block of a second image of the timed sequence, the corresponding block having DCT coefficients correlated to the first set such that the corresponding block represents the intensity pattern at a second time different from the first time; (f) determining a velocity associated with the selected block; and (g) determining the flow rate in response to the velocity.

### BACKGROUND OF THE INVENTION

### 1. Field of Invention

This invention relates to the detection of emissive substances and, in particular, to a method and system for determining a flow rate of a fugitive fluid plume.

### 2. Description of Related Art

Fugitive emissions are emissions of gases or vapors from pressurized equipment due to leaks and other unintended or irregular releases of gases, mostly from industrial activities. Fugitive emissions are believed to cause tremendous economic losses, contribute to air pollution and climate change, and cause catastrophic events.

Many methods have been created to detect fugitive emissions. Some methods involve the deployment of multiple sensors inside the jet flow of a non-fugitive gas stream and having physical contact with the gas stream. Others require the installation of instruments around the gas stream that must be within the field of view of each other. Some methods require the insertion of particles in the gas stream to be used as tracers. However, such methods are intrusive, costly and/or cumbersome to implement.

The Environmental Protection Agency (EPA) of the government of the United States publishes a Leak Detection and Repair (LDAR) method applicable for the determination of Volatile Organic Compounds (VOC) leaks from process equipment, commonly referred to as the EPA's Method 21.

U.S. Pat. No. 6,061,141 to Goldenberg et al. discloses a system and a method to detect the presence of a target vapor of a particular concentration in a monitored area. In one embodiment, the system comprises one radiation source, a beamsplitter, a signal sensor and a reference sensor. The radiation source exposes gas in or from a monitored area to radiation at selected wavelengths. The signal sensor includes a first optical filter which is designed to pass radiation in wavelengths covering the main absorption peak of the vapor to be detected and substantially block other radiation outside the main absorption peak range. The reference sensor includes a second optical filter, which is designed to pass wavelengths surrounding from both sides the main absorption peak and substantially block wavelengths passed by the first optical filter. The system preferably further includes a beamsplitter designed to split the radiation after passing through the target gas into the signal sensor and reference sensor, such that both sensors sense a single field of view, which ensures that non-vapor associated attenuations, due to mist, rain, background radiation and etc, will affect both sensors substantially to the same degree.

However, the system of Goldenberg requires the use of a radiation source which must be physically located on an opposing side of the target vapor as the signal and reference sensors of the system.

P.C.T. application publication No. WO 2011/138,766 A1 to Savary et al. discloses a system and method to remotely measure the directional velocity map of gaseous emissions from a time sequence of camera images. The method comprises acquiring the time sequence of images showing contrasted gas plume information; calculating a time sequence similarity to localize the gas movement in space and time; and determining the directional velocity components in both horizontal and vertical directions. According to the application of Savary, the cross-correlations are computed between all pixels of interest (reference pixels) and the neighboring pixels included in a correlation search window.

However, the use of pixel-by-pixel intensity correlations, as disclosed in Savary et al., results in high noise levels that can lower the quality of the velocity estimates, particularly in the case of low flow rates.

A paper titled “Incremental Learning of 3D-DCT Compact Representations for Robust Visual Tracking” by Xi Li et al., IEEE Transactions on Pattern Analysis and Machine Intelligence, 18 Jul. 2012, discloses a method of visual tracking of a moving object using 3D Discrete Cosine Transform (3D-DCT) algorithm. The complete 3D-DCT based tracking algorithm is composed of three main modules: (1) training sample selection by selecting positive and negative samples for discriminative learning; (2) evaluating likelihood by computing the similarity between candidate samples and the 3D-DCT based observation model; and (3) estimating motion by generating candidate samples and estimate the object state. The object(s) in the target image are identified by comparing the positive and negative samples to each other. However, the system of Xi Li et al. requires the use of a sequence of training samples that are selected from positive and negative samples, and requires the computation of an observation model.

An object of the invention is to address the above shortcomings, and to offer an innovative alternative to the EPA's Method 21.

### SUMMARY

The above shortcomings may be addressed by providing, in accordance with one aspect of the invention, a method of determining a flow rate of a predetermined emissive substance. The method involves: (a) generating a timed sequence of images; (b) partitioning a first image of the timed sequence into a plurality of blocks of pixels; (c) selecting from the plurality of blocks a selected block having calculated therefrom a first set of Discrete Cosine Transform (DCT) coefficients; (d) determining that the first set meets a condition associated with a predetermined threshold such that the first block represents an intensity pattern of the predetermined emissive substance at a first time; (e) selecting a corresponding block of a second image of the timed sequence, the corresponding block having DCT coefficients correlated to the first set such that the corresponding block represents the intensity pattern at a second time different from the first time; (f) determining a velocity associated with the selected block; and (g) determining the flow rate in response to the velocity.

Generating a timed sequence of images may involve generating the timed sequence of the images having pixels. Generating the timed sequence of the images having pixels may involve generating the timed sequence of the images having the pixels, each of the pixels having an intensity value. Generating a timed sequence of images may involve receiving from a first detector a sequence of first-band images. Receiving from a first detector a sequence of first-band images may involve receiving electromagnetic radiation having a first range of wavelengths covering a main absorption peak of the predetermined emissive substance to be detected and substantially blocking other radiation having wavelengths outside the first range. Generating a timed sequence of images may involve receiving from a second detector a sequence of second-band images. Receiving from a second detector a sequence of second-band images may involve receiving electromagnetic radiation having a second range of wavelengths surrounding the main absorption peak on opposing sides thereof and substantially blocking radiation having wavelengths within the first range.

Generating a timed sequence of images may involve generating processed first-band images. Generating processed first-band images may involve applying signal processing to the first-band images. Generating a timed sequence of images may involve generating processed second-band images. Generating processed second-band images may involve applying signal processing to the second-band images. Generating a timed sequence of images may involve generating processed first-band images and processed second-band images by applying signal processing to the first-band images and the second-band images, respectively. Applying signal processing to the first-band images and the second-band images, respectively, may involve applying a smoothing filter. Applying a smoothing filter may involve applying an averaging filter. Applying a smoothing filter may involve applying a Gaussian filter. Applying signal processing to the first-band images and the second-band images, respectively, may involve rotating the second-band images relative to the first-band images. Applying signal processing to the first-band images and the second-band images, respectively, may involve translating the second-band images relative to the first-band images. Applying signal processing to the first-band images and the second-band images, respectively, may involve rotating the first-band images relative to the second-band images. Applying signal processing to the first-band images and the second-band images, respectively, may involve translating the first-band images relative to the second-band images. Applying signal processing to the first-band images and the second-band images, respectively, may involve resizing the first-band images. Applying signal processing to the first-band images and the second-band images, respectively, may involve resizing the second-band images. Generating a timed sequence of images may involve generating a sequence of difference images. Generating a sequence of difference images may involve determining a difference between a first processed first-band image and a first processed second-band image. Determining a difference between a first processed first-band image and a first processed second-band image may involve determining respective differences between the processed first-band images and the processed second-band images. Generating a timed sequence of images may involve generating a sequence of difference images by determining differences between each processed first-band image and each processed second-band image, respectively. Determining differences between each processed first-band image and each processed second-band image, respectively, may involve successively subtracting each processed second-band image from each corresponding first-band image.

Generating a timed sequence of images may involve generating flashing-corrected images in response to the difference images. Generating flashing-corrected images in response to the difference images may involve increasing the contrast of each of the difference images by a factor equal to the ratio between the maximum possible intensity and the maximum intensity occurring in the timed sequence of images. Generating flashing-corrected images in response to the difference images may involve identifying a background image region of background pixels associated with a display, the background pixels excluding a plume flow field associated with the predetermined emissive substance. Identifying the background image region may involve automatically identifying the background image region in response to intensity values of the pixels of the difference images. Identifying the background image region may involve receiving user input identifying the background image region. Receiving user input identifying the background image region may involve receiving a user selection of boundary pixels defining a boundary of the background image region. Generating flashing-corrected images in response to the difference images may involve calculating for each of the difference images a local average intensity associated with the background image region, the local average intensity being equal to the average of the intensity values of the pixels of the each difference image in the background image region. Generating flashing-corrected images in response to the difference images may involve calculating an overall average intensity equal to the average of all of the local average intensities. Generating flashing-corrected images in response to the difference images may involve subtracting, from each pixel of each difference image having an associated local average intensity greater than the overall average intensity, the difference obtained by subtracting the associated local average intensity from the overall average intensity; and subtracting, from each pixel of each difference image having an associated local average intensity less than the overall average intensity, the difference obtained by subtracting the overall average intensity from the associated local average intensity.

Generating a timed sequence of images may involve generating intensity-corrected images in response to the flashing-corrected images. Generating the intensity-corrected images in response to the flashing-corrected images may involve determining a maximum intensity image having at each of its pixels the maximum intensity value of all of the pixels of the flashing-corrected images at the same pixel location. Generating the intensity-corrected images in response to the flashing-corrected images may involve calculating pixel-by-pixel the difference between the maximum intensity image and each flashing-corrected image. Generating the intensity-corrected images in response to the flashing-corrected images may involve replacing the intensity value of each pixel at each pixel location of each flashing-corrected image with the difference between the maximum possible intensity value and the calculated difference. Generating a timed sequence of images may involve assigning to the timed sequence of images the intensity-corrected images.

Partitioning a first image of the timed sequence into a plurality of blocks of pixels may involve partitioning each of first and second images of the timed sequence into blocks of pixels, respectively. Partitioning a first image of the timed sequence into a plurality of blocks of pixels may involve partitioning into fixed and non-overlapping blocks. Partitioning each of first and second images of the timed sequence into blocks of pixels, respectively, may involve partitioning into fixed and non-overlapping blocks. Partitioning a first image of the timed sequence into a plurality of blocks of pixels may involve partitioning into partitioned blocks such that each partitioned block has a predetermined block size. Partitioning each of first and second images of the timed sequence into blocks of pixels, respectively, may involve partitioning into partitioned blocks such that each partitioned block has a predetermined block size. Partitioning into partitioned blocks such that each partitioned block has a predetermined block size may involve partitioning into the partitioned blocks such that each of the partitioned blocks has a block size of 20 by 20 pixels.

The method may involve selecting a selected block of the first image. Selecting from the plurality of blocks a selected block having calculated therefrom a first set of Discrete Cosine Transform (DCT) coefficients may involve selecting the selected block of the first image.

Selecting from the plurality of blocks a selected block having calculated therefrom a first set of Discrete Cosine Transform (DCT) coefficients may involve determining the first set of DCT coefficients associated with the selected block.

Determining that the first set meets a condition associated with a predetermined threshold such that the first block represents an intensity pattern of the predetermined emissive substance at a first time may involve determining whether the first set meets the condition. Determining whether the first set meets the condition may involve determining the first set. Determining that the first set meets a condition associated with a predetermined threshold such that the first block represents an intensity pattern of the predetermined emissive substance at a first time may involve determining the first set. Determining the first set may involve determining the first set of DCT coefficients associated with the selected block. Determining the first set may involve determining two-dimensional DCT coefficients associated with the pixels of the selected block. Determining the first set may involve determining the sum of the absolute values of the first two horizontal Alternating-Current (AC) DCT coefficients. Determining the first set may involve determining the sum of the absolute values of the first two vertical AC DCT coefficients. Determining the first set may involve determining the value of the first diagonal AC DCT coefficient. Determining the first set may involve determining the value of a threshold. Determining whether the first set meets the condition may involve determining the value of the threshold. Determining the value of the threshold may involve determining the value of a first threshold. Determining the value of the threshold may involve scaling the Direct-Current (DC) DCT coefficient by a scaling factor. Determining the value of the threshold may involve dividing the DC DCT coefficient by 100. The method may involve conducting localized spatial noise suppression by setting those DCT coefficients having magnitudes less than the threshold value to zero. Setting those DCT coefficients having magnitudes less than the threshold value to zero may involve setting to zero those DCT coefficients having magnitudes less than the value of the first threshold. Determining the value of the threshold may involve scaling the first threshold to produce a second threshold. Producing a second threshold may involve doubling the first threshold. Determining the value of the threshold may involve doubling the first threshold to produce a second threshold.

Determining whether the first set meets the condition may involve determining whether the sum of the absolute values of the first two horizontal AC DCT coefficients is greater than the value of the threshold. Determining whether the sum of the absolute values of the first two horizontal AC DCT coefficients is greater than the value of the threshold may involve determining whether the sum of the absolute values of the first two horizontal AC DCT coefficients is greater than the value of the second threshold. Determining whether the first set meets the condition may involve determining whether the sum of the absolute values of the first two vertical AC DCT coefficients is greater than the value of the threshold. Determining whether the sum of the absolute values of the first two vertical AC DCT coefficients is greater than the value of the threshold may involve determining whether the sum of the absolute values of the first two vertical AC DCT coefficients is greater than the value of the second threshold. Determining whether the first set meets the condition may involve determining whether the value of the first diagonal AC DCT coefficient is not equal to zero. Determining whether the first set meets the condition may involve determining whether the sum of the absolute values of the first two horizontal AC DCT coefficients is greater than the value of the threshold, the sum of the absolute values of the first two vertical AC DCT coefficients is greater than the value of the threshold, and the value of the first diagonal AC DCT coefficient is not equal to zero. Determining whether the first set meets the condition may involve re-selecting a selected block of the first image in response to determining that the first set does not meet the condition. Determining whether the first set meets the condition may involve determining the first set of DCT coefficients associated with the selected block in response to re-selecting the selected block.

Selecting a corresponding block of a second image of the timed sequence, the corresponding block having DCT coefficients correlated to the first set such that the corresponding block represents the intensity pattern at a second time different from the first time, may involve selecting from the second image the corresponding block having DCT coefficients that are correlated with the first set. Selecting from the second image a corresponding block having DCT coefficients that are correlated with the first set may involve selecting the corresponding block. Selecting the corresponding block may involve selecting in response to determining that the first set meets the condition.

Selecting the corresponding block may involve selecting a location within a search window of the second image. Selecting the corresponding block may involve determining a second set of two-dimensional DCT coefficients associated with the pixels of an associated block associated with the selected location. Selecting the corresponding block may involve determining a sum of the absolute differences between the respective DCT coefficients of the first set and the second set, and associating the sum with the selected location. Selecting the corresponding block may involve determining whether all locations have been processed. Selecting the corresponding block may involve, in response to determining that all of the locations have not been processed, selecting another location as a selected location, determining a second set of two-dimensional DCT coefficients associated with the pixels of an associated block associated with the selected location, determining a sum of the absolute differences between the respective DCT coefficients of the first set and the second set, and associating the sum with the selected location. Selecting the corresponding block may involve, in response to determining that all of the locations have been processed, assigning to the corresponding block the associated block having the smallest associated sum.

Determining a velocity associated with the selected block may involve determining the velocity in response to the selected block and the corresponding block. Determining the velocity in response to the selected block and the corresponding block may involve determining the magnitude and direction of the velocity. Determining the magnitude of the velocity may involve dividing the magnitude of a displacement between the spatial locations of the selected block and the corresponding block by a time difference between the first and second images. Determining the direction of the velocity may involve determining a direction of the displacement. Determining a velocity associated with the selected block may involve storing the velocity in association with the selected block. Storing the velocity in association with the selected block may involve storing the velocity in memory. Storing the velocity in association with the selected block may involve storing a plurality of stored velocities in association with a plurality of selected blocks, respectively. Determining a velocity associated with the selected block may involve determining respective pluralities of velocities in association with a plurality of images of the timed sequence. Determining a velocity associated with the selected block may involve storing the respective pluralities of velocities in association with the plurality of images.

Determining the flow rate in response to the velocity may involve determining the flow rate in response to the plurality of stored velocities. Determining the flow rate in response to the velocity may involve determining whether all of the blocks of the first image have been processed. Determining the flow rate in response to the velocity may involve, in response to determining that all of the blocks of the first image have not been processed, re-selecting a selected block of the first image, determining a further set of DCT coefficients associated with the selected block, determining that the further set meets the condition, re-selecting from the second image a corresponding block having DCT coefficients that are correlated with the further set, determining a velocity in response to the selected block and the corresponding block, and storing the velocity in association with the selected block.

Determining that the further set meets the condition may involve, in response to determining that the further set does not meet the condition, re-selecting a selected block of the first image and determining a further set of DCT coefficients associated with the selected block. Determining the flow rate in response to the velocity may involve, in response to determining that all of the blocks of the first image have been processed, determining the flow rate in response to the plurality of stored velocities. Determining the flow rate in response to the velocity may involve determining the flow rate in response to the respective pluralities of stored velocities. Determining the flow rate in response to the velocity may involve, in response to determining that all of the blocks of the plurality of images have been processed, determining the flow rate in response to the respective pluralities of stored velocities.

Determining the flow rate in response to the velocity may involve identifying a plume image region circumscribing at least a portion of the plume flow field. Identifying the plume image region may involve automatically identifying the plume image region in response to intensity values of pixels of the images of the timed sequence. Identifying the plume image region may involve receiving user input identifying the plume image region. Receiving user input identifying the plume image region may involve receiving a user selection of boundary pixels defining a boundary of the plume image region. Determining the flow rate in response to the velocity may involve determining a boundary velocity at each of the boundary pixels, the boundary velocity being normal to the boundary. Determining the flow rate in response to the velocity may involve determining, at each of the boundary pixels, the multiplication product of the boundary velocity times the intensity value of the each boundary pixel. Determining the flow rate in response to the velocity may involve determining an exit sum of positive multiplication products, the multiplication product of the each positive multiplication product being greater than zero. Determining the flow rate in response to the velocity may involve determining an entry sum of negative multiplication products, the multiplication product of the each negative multiplication product being less than zero. Determining the flow rate in response to the velocity may involve comparing the exit sum and the entry sum. Determining the flow rate in response to the velocity may involve determining a flow-rate product of the exit sum and a proportionality constant, and assigning to the flow rate the flow-rate product. Determining a flow-rate product of the exit sum and a proportionality constant may involve determining the flow-rate product of the exit sum and the proportionality constant, the proportionality constant having been predetermined empirically. Determining the flow rate in response to the velocity may involve determining an entry flow-rate product of the entry sum and the proportionality constant, and assigning to the flow rate the entry flow-rate product. Determining an entry flow-rate product of the entry sum and the proportionality constant may involve determining the entry flow-rate product of the entry sum and the proportionality constant, the proportionality constant having been predetermined empirically. Determining the flow rate in response to the velocity may involve identifying a plurality of plume regions, determining in association with the plume regions a plurality of respective exit sums, determining an average of the plurality of the respective exit sums, and assigning to the flow rate the product of the average and the proportionality constant. Determining the flow rate in response to the velocity may involve identifying a plurality of plume regions, determining in association with the plume regions a plurality of respective entry sums, determining an average of the plurality of the respective entry sums, and assigning to the flow rate the product of the average and the proportionality constant.

Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a block diagram of a system, according to one embodiment of the invention, for determining a flow rate of a predetermined emissive substance;

FIG. 2 is a flow diagram of a method of determining the flow rate when performed by the system shown in FIG. 1, showing partitioning each of first and second images of a timed sequence into blocks of pixels, respectively;

FIG. 3 is a flow diagram of an exemplary method of performing the step shown in FIG. 2 of generating the timed sequence of images, showing generating a sequence of difference images;

FIG. 4 is a flow diagram of an exemplary method of performing the step shown in FIG. 2 of determining a first set of Discrete Cosine Transform (DCT) coefficients, showing determining two-dimensional DCT coefficients associated with the pixels of a selected block;

FIG. 5 is a flow diagram of an exemplary method of performing the step shown in FIG. 2 of determining whether the first set meets a threshold condition, showing a plurality of comparisons involving a threshold; and

FIG. 6 is a flow diagram of an exemplary method of performing the step shown in FIG. 2 of selecting a corresponding block, showing determining a second set of DCT coefficients;

FIG. 7 is a flow diagram of an exemplary method of performing the step shown in FIG. 2 of determining a velocity and a flow rate, showing determining the flow rate in response to a plurality of stored velocities;

FIG. 8 is a graphical representation of a difference image showing the presence of a fugitive fluid plume; and

FIG. 9 is a graphical representation of the fugitive fluid plume shown in FIG. 8, showing velocity vectors.

### DETAILED DESCRIPTION

A system for determining a flow rate of a predetermined emissive substance includes: (a) generating means for generating a timed sequence of images; (b) partitioning means for partitioning a first image of the timed sequence into a plurality of blocks of pixels; (c) first selecting means for selecting from the plurality of blocks a selected block having calculated therefrom a first set of Discrete Cosine Transform (DCT) coefficients; (d) comparison means for determining that the first set meets a condition associated with a predetermined threshold such that the first block represents an intensity pattern of the predetermined emissive substance at a first time; (e) second selecting means for selecting a corresponding block of a second image of the timed sequence, the corresponding block having DCT coefficients correlated to the first set such that the corresponding block represents the intensity pattern at a second time different from the first time; (f) first computational means for determining a velocity associated with the selected block; and (g) second computational means for determining the flow rate in response to the velocity.

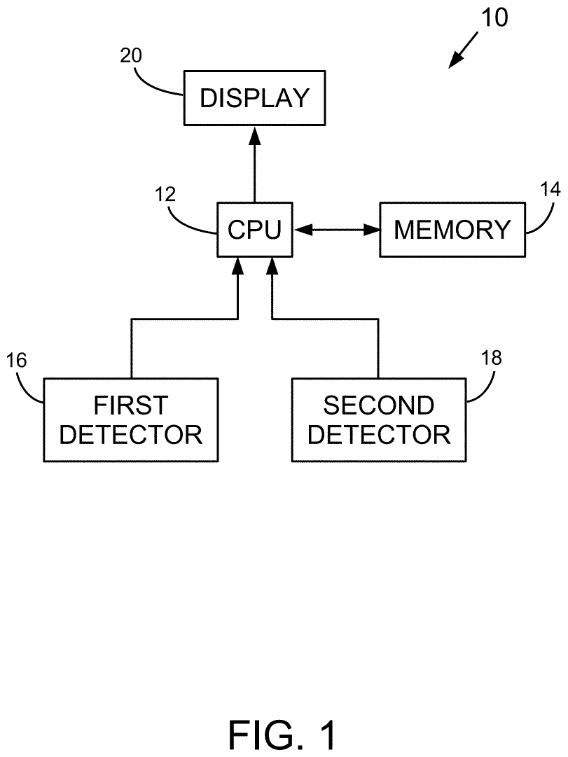

Referring to FIG. 1, the system is shown generally at 10. The system 10 according to one embodiment of the invention is operable to determine a flow rate of a predetermined emissive substance such as a gas, vapor or other fugitive fluid. Typically, the fugitive fluid forms a fugitive fluid plume adjacent a source of a leak of the predetermined emissive substance. In at least one embodiment, the system 10 is implemented as a digital camera or other imaging device. In addition to the features disclosed herein, the system 10 may also incorporate one or more features disclosed in U.S. Pat. No. 7,189,970 to Symons and Racca, which is entitled Imaging of Fugitive Gas Leaks, and/or U.S. Pat. No. 9,638,846 to Parsons, which is entitled Apparatus and Method for Multi-Spectral Dual Balanced Imaging.

The system 10 includes at least one first detector 16 and at least one second detector 18. The first detector 16 is operable to detect electromagnetic radiation having a prime band of wavelengths, while the second detector 18 is operable to detect electromagnetic radiation having a reference band of wavelengths, or vice versa in alternative embodiments.

In one embodiment, the prime band is centered on a wavelength of interest, such as an infrared absorption wavelength associated with the predetermined emissive substance. In the first embodiment, the reference band includes wavelengths both adjacently higher and lower than those of the prime band, but excludes the prime band wavelengths. For example, when the predetermined emissive substance is Methane gas, the prime band or the prime range of wavelengths is typically 3.30-3.34 μm, while the reference band or the reference range of wavelengths is typically 3.28-3.30 μm and 3.34-3.36 μm.

In communication with both the first detector 16 and the second detector 18 is a Central Processing Unit (CPU) 12 operable to receive digital signals representing electromagnetic radiation detected by the first and second detectors 16 and 18, operable to execute a method of determining the flow rate of the predetermined emissive substance and also operable to display the result. Typically, the CPU 12 is an electronic circuitry within a computer that carries out the instructions of a computer program by performing the basic arithmetic, logical, control and input/output (I/O) operations specified by the instructions.

In communication with the CPU 12 is a memory 14 operable to store computer program instructions and data. Typically, the Memory 14 is all or part of a digital electronic integrated circuit or formed from a plurality of digital electronic integrated circuits. The Memory 14 may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example. The Memory 14 may be operable to store digital representations as volatile memory, non-volatile memory, dynamic memory, etc. or any combination thereof. The Memory 14 in one embodiment is operable to store digital representations of data, such as data originating from the first detector 16 and the second detector 18 or other information, including measurement results, such as velocity results, and/or control information, and to store digital representations of program data or other information, including program code for directing operations of the CPU 12.

In communication with the CPU 12 is also a display 20 operable to show the results generated from the CPU 12. In one embodiment, the display 20 is a computer screen, such as a Liquid Crystal Display (LCD). In some embodiments, the display 20 is a colour display.

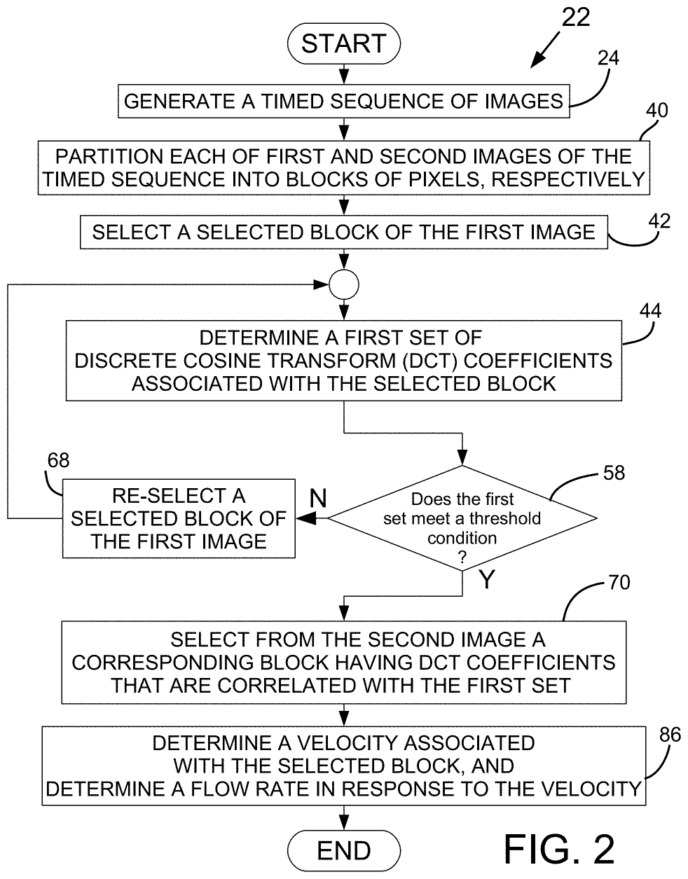

Referring to FIG. 2, the Memory 14 (FIG. 1) in accordance with one embodiment of the invention contains coding blocks comprising computer executable instructions for directing the CPU 12 to perform the steps of a method shown generally at 22.

When the system 10 is in operation such that electrical power is being supplied to the CPU 12 and the Memory 14, the CPU 12 is directed to perform steps of the method 22 of determining the flow rate of the predetermined emissive substance.

The method 22 begins execution at the coding block 24, which directs the CPU 12 to generate a timed sequence of images. In one embodiment, each image is produced by the system 10 (FIG. 1) such that each image consists of a predetermined array of pixels, each pixel being represented digitally by at least a pixel intensity value and an address indicating its pixel location within the image. Typically, each image is produced at a different time and the images in the timed sequence are ordered chronologically, such that each image is a video frame of a video and the timed sequence is a video, for example.

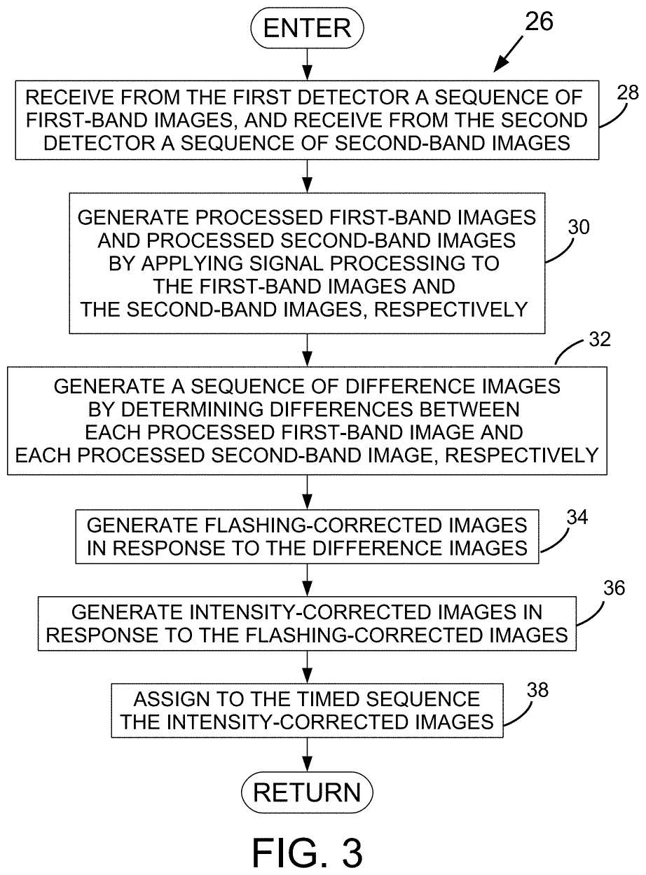

Referring to FIG. 3, an exemplary method of performing steps of coding block 24 (FIG. 2) is shown generally at 26.

Coding block 28 directs the CPU 12 to receive a sequence of first-band images from the first detector 16 and to receive a sequence of second-band images from the second detector 18. The first-band images, which can also be called prime-band images, are images which record the electromagnetic radiation in wavelengths covering the main absorption peak of the emissive substance to be detected and substantially block other radiation outside the main absorption peak range. The second-band images, which can also be called reference-band images, are images which record the electromagnetic radiation in wavelengths surrounding the main absorption peak (i.e. on opposing sides thereof) and substantially blocking wavelengths within the main absorption peak range. For example, when the emissive substance to be detected is Methane for one embodiment, the first band or prime band of wavelengths is about 3.30-3.34 μm, while the second band or reference band of wavelengths is about 3.28-3.30 μm and 3.34-3.36 μm. As a result, in the absence of a fugitive emission, images representing prime and reference bands are highly correlated. However, during emission of a detectable emissive substance forming a fugitive fluid plume, difference images generated by the digital subtraction of the first-band from the second-band images, are able to show the presence of the fugitive fluid plume.

Coding block 30 directs the CPU 12 to generate processed first-band images and processed second-band images by applying signal processing to the first-band images and the second-band images, respectively. Smoothing filters, such as averaging and/or Gaussian filters, may be employed to reduce noise in the first-band images and the second-band images. To reduce the geometrical distortion between the images, the reference-band or the second-band images may be rotated and/or translated relative to the prime or the first-band images, for example. In some embodiments, the generated images are resized to capture the useful portion of the fluid flow-field for subsequent processing.

Coding block 32 directs the CPU 12 to generate a sequence of difference images by determining differences between each processed first-band image and each processed second-band image, respectively. In one embodiment, the difference image is generated by successive subtraction of each reference-band image from each prime band image, respectively. Ideally, a complete cancellation of background intensity occurs in the background of each difference image where there is no fugitive fluid plume. However, in practice this is generally not the case, and the difference images may show a residual background and/or flicker in the background.

Coding block 34 directs the CPU 12 to generate flashing-corrected images in response to the difference images. The flashing-corrected images advantageously have reduced flicker. In one embodiment, the flashing-corrected images are generated by first increasing the contrast of each difference frame by a factor equal to the ratio between the maximum possible intensity value (e.g. 255 for an 8-bit camera) and the maximum intensity occurring in the video sequence. This operation preserves the relative intensity levels between the pixels that define the fluid plume density. Next, a non-plume region outside the plume flow field is identified. In one embodiment, the CPU 12 is directed to receive user input identifying the non-plume region. In some embodiments, however, the CPU 12 is directed to automatically identify the non-plume region, such as by locating a non-plume region in which the variation of intensity between successive video frames is minimal or otherwise within a specifiable minimal range. In some embodiments, locating the non-plume region is executed as part of an initial calibration routine. Thereafter, the CPU 12 is directed to calculate for each video frame a local average intensity (I_{f}) equal to the average intensity of the pixels within the non-plume region of each video frame. Then, the CPU 12 is directed to calculate an overall average intensity (Iₒ) across the frames, as expressed in equation 1.

$${I}_{o} = \frac{{\sum }_{i = 1}^{N} {( {I}_{f} )}_{i}}{N} \qquad ( 1 )$$

Where N is the number of image frames in the video sequence.

Next, the difference between the local average intensity (I_{f}) of each frame and the overall (Iₒ) average intensity is determined. Thereafter, if the local average intensity (I_{f}) for a given frame is greater than the overall average intensity (Iₒ), then the intensity of each pixel of that given frame is adjusted by subtracting from all pixel intensities in the given frame the calculated difference of the overall average intensity (Iₒ) minus the local average intensity (I_{f}), i.e. (Iₒ−I_{f}). Also, if the local average intensity (I_{f}) for a given frame is less than the overall average intensity (Iₒ), then the intensity of each pixel of that given frame is adjusted by subtracting from all pixel intensities in the given frame the calculated difference of the local average intensity (I_{f}) minus the overall average intensity (Iₒ), i.e. (I_{f}−Iₒ). As a result, flashing-corrected images are generated.

Each flashing-corrected image typically includes a foreground with varying pixel intensities, each pixel intensity being representative of the fluid plume density at its two-dimensional pixel location within the flashing-corrected image, and a background with reduced flicker that in some circumstances may be grainy with somewhat varying intensities.

Coding block 36 directs the CPU 12 to generate intensity-corrected images in response to the flashing-corrected images. Typically, generating the intensity-corrected images advantageously reduces the effect of uneven background intensity that may be found in the flashing-corrected images.

To generate the intensity-corrected images, in one embodiment the CPU 12 is directed to generate a maximum intensity image consisting of all maximum intensities for each pixel location across the video frames. Next, the CPU 12 is directed to subtract the maximum intensity image from each of the video frames in the flashing-corrected images and apply a range of thresholds approach to extract the fluid plume density. As a result, the maximum intensity corrected images, which typically at least contain the density information of the moving plume, are generated.

By way of further example of generating intensity-corrected images, in a given sequence of flashing-corrected images the colour pure white may be represented as having a pixel intensity of 255 (i.e. the exemplary maximum possible value), while the colour pure black may be represented as having a pixel intensity of 0 (zero). In this example, the maximum intensity image has at each of its pixels the maximum intensity value (i.e. closest to the colour pure white) of all pixels of the sequence at the same pixel location. The difference between the maximum intensity image and each image of the sequence is calculated to determine how “far” each pixel is from being the closest to the colour pure white at that pixel location. Thereafter, the intensity value of each pixel at each pixel location of each image is replaced with the difference between the intensity value of the colour pure white (e.g. 255) and the calculated difference, thereby obtaining images in which the pixel at a given pixel location that previously was the closest to being pure white becomes pure white with a corresponding intensity shift of the other pixels at that same pixel location. Thereafter, a threshold is applied such that pixels having intensity values close to white (e.g. 190 to 255) have their intensity values replaced with pure white (e.g. 255) and pixels having intensity values close to black (e.g. 0 to 12) have their intensity values replaced with pure black (e.g. 0). Accordingly, if the pixels at a given pixel location across the video frames of the video sequence vary little in intensity one from the other (as typically occurs at pixel locations associated with a static background), then such pixels of the intensity-corrected images become close to white and, after applying the threshold, may become pure white. On the other hand, if the pixels at a given pixel location vary significantly in intensity over a period of time (as typically occurs at pixel locations associated with an active fugitive fluid plume), then such pixels of the intensity-corrected images maintain their significant variation of intensity. The result is that the fugitive fluid plume appears on the display 20 (FIG. 1) as a dark moving foreground against a white background.

In some embodiments, the display 20 (FIG. 1) is a colour display and the foreground showing the fugitive fluid plume and/or the background are colourized according to any desired colour scheme, which may be under user control for example.

Also, a typical effect of executing coding block 36 is to lose plume information close to the nozzle. This effect occurs since the plume is typically stationary and equal to the maximum pixel intensity in this region across all frames in the flashing corrected images. Thus, the subsequent operation of subtracting the maximum intensity frame can remove the plume density information in this region. However, this region of stationary and maximum intensity close to the nozzle typically represents a small fraction of the total volume and area of the entire plume, and thus has a minimal or negligible impact on the determination of the flow rate and the appearance on the display 20 of the fugitive fluid plume.

Some embodiments also include further image processing. For example, digital motion compensation techniques may be employed to compensate for movement over time of the system 10 (FIG. 1), including its detectors 16 and 18, relative to the physical location of the fugitive fluid plume.

Coding block 38 directs the CPU 12 to assign to the timed sequence of images the intensity-corrected images.

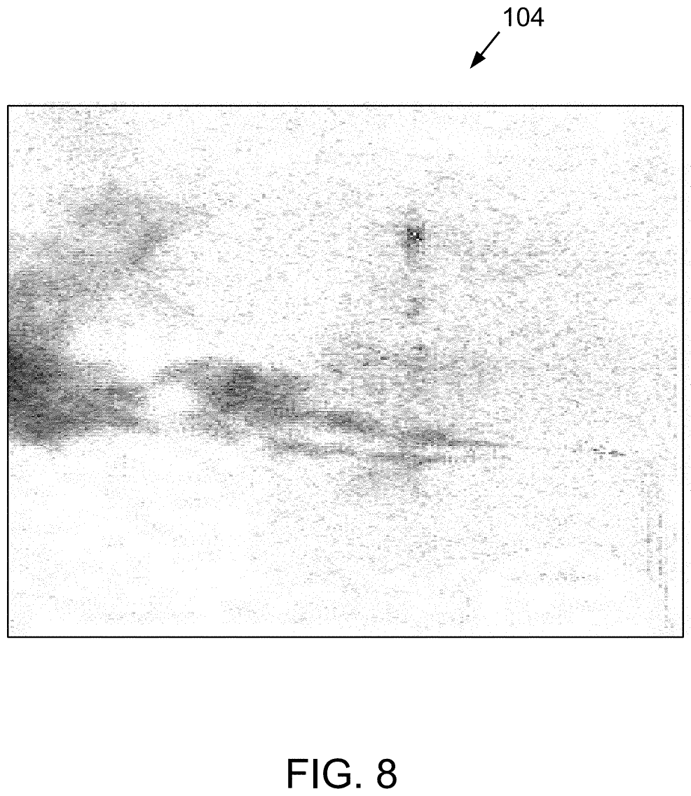

FIG. 8 shows one exemplary intensity-corrected image 104 in accordance with the present invention. The timed sequence of images may be displayed on the display 20 (FIG. 1) sequentially as a video, for example.

The method 26 is completed at this point and the CPU 12 is directed to return to the method 22 at coding block 40, as shown in FIG. 2.

Coding block 40 directs the CPU 12 to partition each of first and second images of the timed sequence into blocks of pixels, respectively. In this step, each given frame may be partitioned into fixed and non-overlapping blocks, for example. Such block partitioning advantageously allows the subsequent processing operation to be well adapted to the local structure of the fugitive fluid plume. The optimal block size will depend on several factors, such as the quality of the images, processing speed, expected extent of the plume flow field, and characteristic size of features of turbulence and eddies within the flow field and desired resolution of the determined motion vectors. The 20 by 20 pixels block size might be an option, although in practice the block size may be larger or smaller. In variations of embodiments, the partitioning process can be implemented manually, automatically or any combination thereof for example.

Coding block 42 directs the CPU 12 to select, as a selected block, a block of the first image. The selected block may be selected by order of indexing or at random, for example. In some embodiments, a pre-processing operation is employed to identify in advance the image blocks to be selected.

Coding block 44 directs the CPU 12 to determine a first set of Discrete Cosine Transform (DCT) coefficients associated with the selected block.

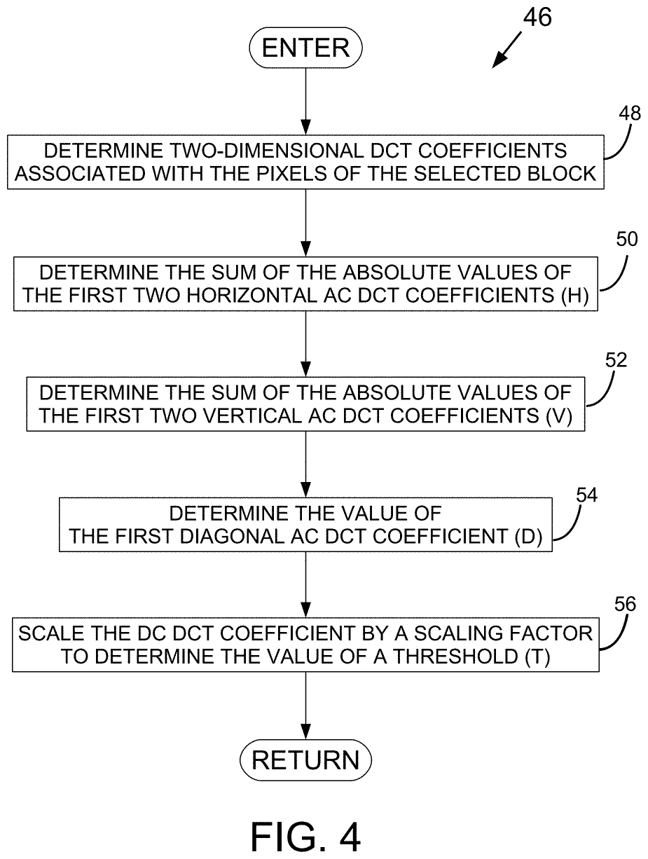

Referring to FIG. 4, an exemplary method of performing steps of the coding block 44 (FIG. 2) is shown generally at 46.

Coding block 48 directs the CPU 12 to determine two-dimensional DCT coefficients associated with the pixels of the selected block. For example, for a n by n block having a block size of n², all the possible DCT coefficients are DC, AC₀₁, AC₁₀, AC₂₀, AC₁₁, AC₀₂, . . . , AC₀ₙ, ACₙ₀, . . . AC₍ₙ₋₁₎ₙ, ACₙ₍ₙ₋₁₎, ACₙₙ. The zero spatial frequency is represented by the coefficient DC (Direct-Current). The higher spatial frequencies are represented by AC (Alternating-Current) coefficients. The AC coefficients can further be categorized as horizontal AC coefficients (e.g. AC₀₁, AC₀₂, AC₀ₙ), vertical AC coefficients (e.g. AC₁₀, AC₂₀, . . . ACₙ₀) and diagonal AC coefficients (e.g. AC₁₁ . . . ACₙₙ).

Coding block 50 directs the CPU 12 to determine the sum of the absolute values of the first two horizontal AC DCT coefficients (H). For example, for a block size of n by n pixels where n is greater than or equal to two, H is AC₀₁+AC₀₂.

Coding block 52 directs the CPU 12 to determine the sum of the absolute values of the first two vertical AC DCT coefficients (V). For example, for a block size of n by n pixels where n is greater than or equal to two, V is AC₁₀+AC₂₀.

Coding block 54 directs the CPU 12 to determine the value of the first diagonal AC DCT coefficient (D). For example, for a block size of n by n pixels where n is greater than or equal to two, D is AC₁₁.

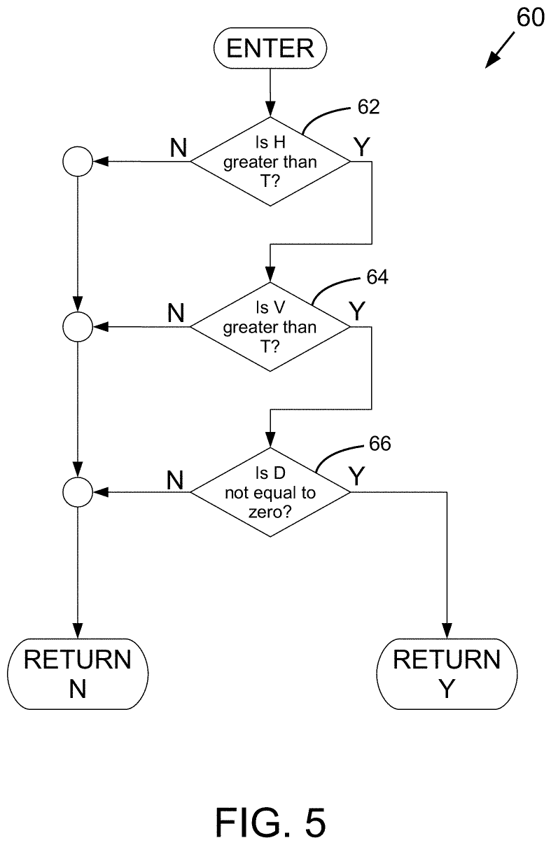

In one embodiment, the first set of DCT coefficients consists of the first two horizontal AC DCT coefficients (H), the first two vertical AC DCT coefficients (V), the first diagonal AC DCT coefficient (D), and the DC DCT coefficient. Coding block 56 directs the CPU 12 to scale the DC DCT coefficient by a scaling factor to determine the value of a threshold (T). A variable threshold method may be implemented. For example, the threshold value (T) for a given block of DCT coefficients may be obtained by scaling the corresponding DC coefficient by 100 (i.e. dividing the DC coefficient by 100). In some embodiments, localized spatial noise suppression is applied by setting those DCT coefficients with magnitudes less than the threshold value (T) to zero. DCT coefficients having magnitudes less than the threshold value (T) typically represent high frequency noise components, thus localized spatial noise suppression advantageously reduces high frequency noise. Thereafter, the value of the threshold (T) is doubled, for example, for use as the threshold (T) in the method 60 (FIG. 5) described herein below.

The method 46 is completed at this point and the CPU 12 is directed to return to the method 22 at coding block 58, as shown in FIG. 2.

Coding block 58 directs the CPU 12 to determine whether the first set meets a threshold condition.

Referring to FIG. 5, an exemplary method of performing steps of coding block 58 (FIG. 2) is shown generally at 60.

Coding block 62 directs the CPU 12 to determine whether the sum of the absolute values of the first two horizontal AC DCT coefficients (H) is greater than the value of the threshold (T).

Coding block 64 directs the CPU 12 to determine whether the sum of the absolute values of the first two vertical AC DCT coefficients (V) is greater than the value of the threshold (T).

Coding block 66 directs the CPU 12 to determine whether the value of the first diagonal AC DCT coefficient (D) is not equal to zero.

If the answers of coding block 62, 64 and 66 are all yes, namely when (H>T) and (V>T) and (D≠0), return yes. Otherwise, return no. The method 60 is complete at this point and the CPU 12 is directed to return to the method 22 at coding block 68 or 70 depending on the result, as shown in FIG. 2.

If the result of method 60 is no, the CPU 12 is directed to execute coding block 68, which directs the CPU 12 to re-select another block of the first image as the selected block, and then return to the coding block 44 previously described herein above.

If the result of method 60 is yes, the CPU 12 is directed to execute coding block 70, which directs the CPU 12 to select from the second image a corresponding block having DCT coefficients that are correlated with the first set. When the result of method 60 (FIG. 5) is yes, it means an object has been successfully identified in the currently selected block. It should be noted that the term “object” in this context refers to any intensity pattern relating to the plume flow field. With reference to coding block 70 of FIG. 2, once an object has been identified in the selected block of the current frame, a correlation with a translated block within a search region in the reference/remaining frame may be applied. It should be noted that a correlation of spatially-filtered sets of DCT coefficients, rather than pixel-by-pixel intensity correlation, is applied.

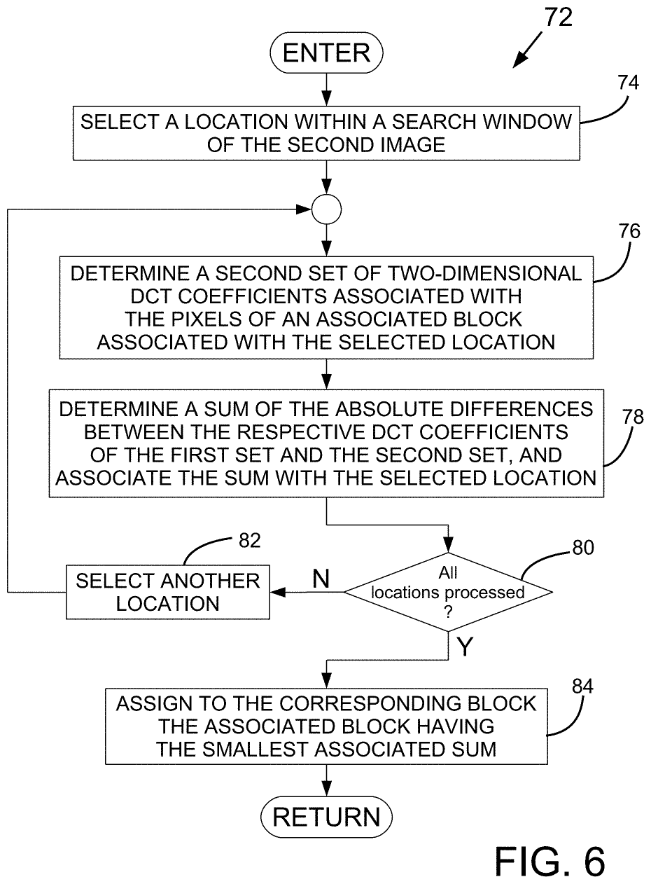

Referring to FIG. 6, an exemplary method of performing steps of the coding block 70 (FIG. 2) is shown generally at 72. Coding block 74 directs the CPU 12 to select a location within a search window of the second image. In some embodiments, the search window size is determined automatically, such as being determined based on statistical factors. For example, an empirically determined constant window size may be employed, with the search window being centered about a location in the second image that corresponds to the location of the selected block of the first image. In some embodiments, the user defines a window encompassing the visible plume on the display 20 (FIG. 1), and the location and size of the second image search window is determined to correspond to the user-selected window. Other methods of selecting a search window and a location within the search window are possible. For example, in some embodiments a variable window size is automatically determined.

Coding block 76 directs the CPU 12 to determine a second set of two-dimensional DCT coefficients associated with the pixels of a block associated with the selected location. Herein, the block associated with the selected location is referred to as the associated block. Coding block 76 may be executed in a manner similarly or analogously to coding block 44 (FIG. 2), for example.

Coding block 78 directs the CPU 12 to determine the sum of the absolute differences between the respective DCT coefficients of the first set and the second set. Thereafter, the CPU 12 is also directed to associate the sum with the location previously selected by executing coding block 74.

Coding block 80 directs the CPU 12 to determine whether all locations have been processed. If no, then coding block 82 directs the CPU 12 to select another location and then return to coding block 76 previously described herein above. If yes, then coding block 84 directs the CPU 12 to assign to the corresponding block the particular associated block which is determined by the CPU 12 to have the smallest associated sum. Typically, the associated block having the smallest sum is the associated block of the second image that correlates most closely, by DCT coefficient block matching, to the selected block of the first image.

The method 72 is complete after executing coding block 84 and the CPU 12 is directed to return to the method 22 at coding block 86, as shown in FIG. 2.

Coding block 86 directs the CPU 12 to determine a velocity associated with the selected block, and determine a flow rate in response to the velocity.

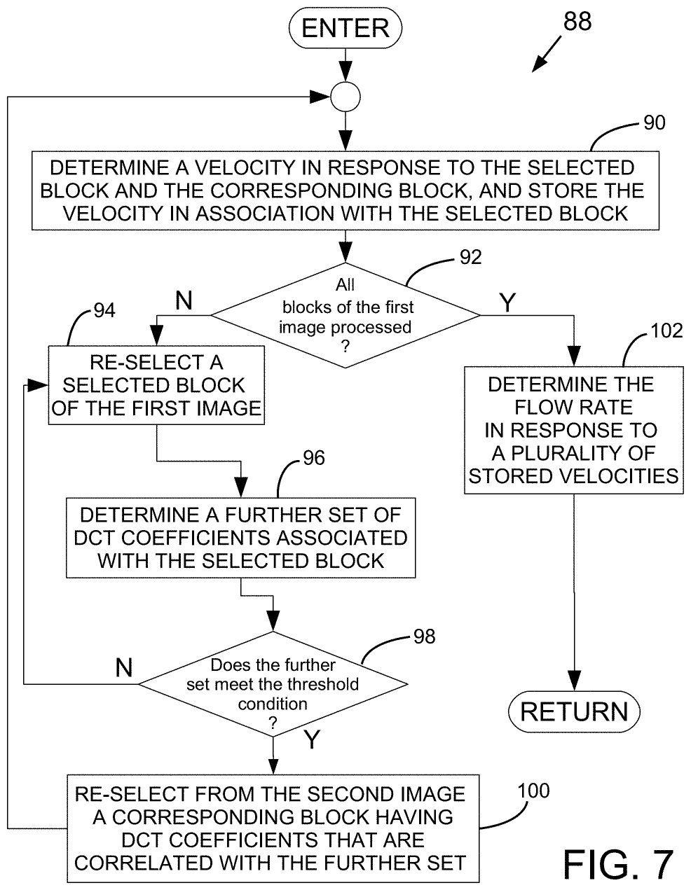

Referring to FIG. 7, an exemplary method of performing steps of the coding block 86 (FIG. 2) is shown generally at 88.

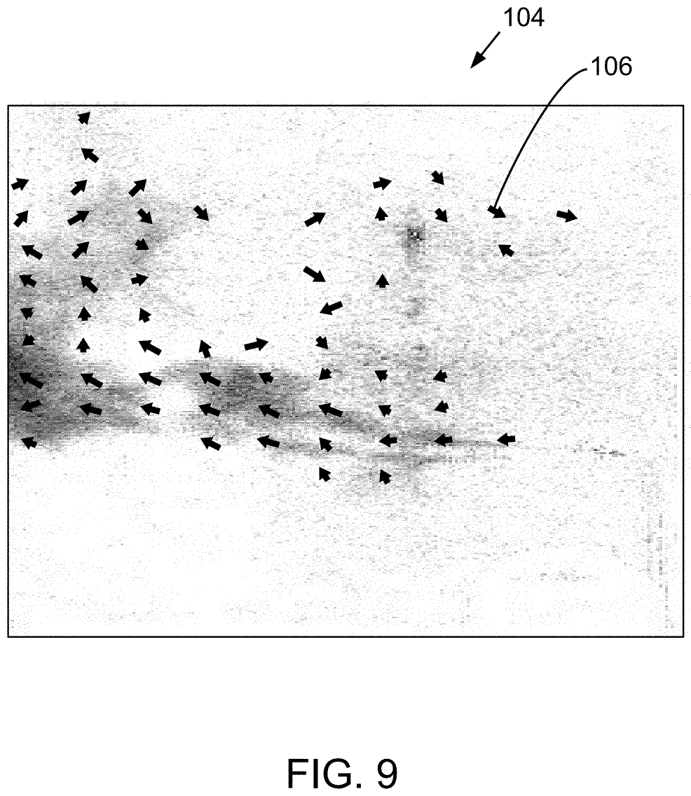

Coding block 90 directs the CPU 12 to determine a velocity in response to the selected block and the corresponding block, and then directs the CPU 12 to store in the Memory 14 the velocity in association with the selected block. Typically, the velocity is represented as a vector having a magnitude and direction. In one embodiment, the magnitude of the velocity vector is determined by dividing the distance (i.e. magnitude of the displacement) between the relative two-dimensional (horizontal and vertical) spatial locations of the selected block and the corresponding block by the time difference between the first and second images, the time difference being determined in accordance with the chronological order of the timed sequence of images. Also, the direction of the displacement gives the direction of the velocity vector. In some embodiments, the velocity vector is stored in association with both the selected block and the corresponding block. Each arrow 106 shown in FIG. 9 graphically represents velocity vectors in association with blocks of the intensity-corrected image 104 (FIG. 8), which may include the selected block used when executing the coding block 90.

Coding block 92 directs the CPU 12 to determine whether all of the blocks of the first image have been processed.

If no, then coding block 94 directs the CPU 12 to re-select, as a selected block, another block of the first image.

Coding block 96 then directs the CPU 12 to determine a further set of DCT coefficients associated with the (newly) selected block. Then coding block 98 directs the CPU 12 to determine whether the further set meets the threshold condition.

If by executing coding block 98 the CPU 12 determines that the further set does not meet the threshold condition, then the process returns to coding block 94 and then coding block 96 for re-execution as previously described herein above.

If by executing coding block 98 the CPU 12 determines that the further set meets the threshold condition, then coding block 100 directs the CPU 12 to select from the second image a corresponding block having DCT coefficients that are correlated with the further set.

After coding block 100 has been executed, the process returns to coding block 90 for re-execution as previously described herein above in respect of the re-selection of the selected block and its corresponding block. Coding blocks 94, 96, 98 and 100 may be executed in a manner similarly or analogously to coding blocks 42, 44, 58 and 70 (FIG. 2), respectively, for example.

If the result of executing coding block 92 is yes, then coding block 102 directs the CPU 12 to determine the mass flow rate in response to a plurality of stored velocities. Typically, the stored velocities are stored in the Memory 14.

In one embodiment, coding block 102 directs the CPU 12 to calculate the flow rate after a plume image region circumscribing at least a portion of the plume flow field has been identified. The plume image region may be identified automatically or on the basis of user input (e.g. a user-drawn box enclosing a region of the visible plume and preferably the source of any fugitive leak), for example. Next, the CPU 12 is directed to calculate the velocity normal to each point along the boundary of the plume image region, and to determine multiplication products by multiplying each of the normal velocities by the intensity values of the corresponding pixels at the boundary points. The CPU 12 is then directed to calculate an exit sum of all the multiplication products associated with velocities representing plume flow exiting the plume image region is determined. Additionally or alternatively, the CPU 12 may be directed to calculate an entry sum of all the multiplication products associated with velocities representing plume flow entering the plume image region. By the assumption of conservation of total flux for a constant flow rate over a reasonably short period of time, the sum of the exit sum and the entry sum should be equal to zero. In some embodiments, both the exit sum and the entry sum are determined and compared to each other by the CPU 12 to determine whether there is any measurement error. The CPU 12 is then directed to multiply a flow-rate sum (i.e. one of the exit sum and the entry sum) by a proportionality constant to determine the flow rate. Typically, the proportionality constant is predetermined empirically as a relationship between intensity values of pixels within a plume image region and empirically measured plume densities of known emissive substances emitted at a known leak rate. The empirically determined relationship may be a calibration factor of the system 10 (FIG. 1), for example.

In some embodiments, the CPU 12 is directed to determine a plurality of flow rates associated with a plurality of different plume image regions, and to determine an average flow rate in response to the plurality of flow rates.

In one embodiment, the CPU 12 is directed to display the flow rate on the display 20 (FIG. 1) and to store the flow rate in the Memory 14 (FIG. 1).

After coding block 102 has been executed, then the method 88 is complete and the CPU 12 is directed to return to the method 22 as shown in FIG. 2. In one embodiment, image partitioning and the steps of coding blocks 42, 44, 58, 68, 70 and 86 are iteratively executed by the CPU 12 until a selected plurality of the images (e.g. all the images) of the time sequence have been processed. Then the method 22 is complete.

In some embodiments, the method 22 is executed only in respect of the pixels of the background and plume image regions, thereby minimizing CPU 12 processing requirements. In some embodiments, the method 22 is executed only in respect of the pixels of the background image region and the boundary pixels of the plume image region, thereby further minimizing CPU 12 processing requirements. For example, in some embodiments the coding block 42 (FIG. 1) directs the CPU 12 to constrain the selection of the selected block of the first image such that the first block intersects with the boundary of the plume image region. Other related modifications to gain computational efficiencies will become apparent to one of ordinary skill in the art upon reviewing the disclosure herein.

In some embodiments, the method 22 or portions thereof are iteratively executed in respect of different block sizes for the selected and/or corresponding blocks of pixels. In some embodiments, the block size is a calibration factor stored in the Memory 14 (FIG. 1), and such calibration factor may be user-adjustable.

Coding block 44 (FIG. 2) in some embodiments directs the CPU 12 to determine a first set of transform coefficients other than DCT coefficients. For example, a wavelet transform may be suitably employed, provided corresponding changes are made to the coding blocks related to determining whether an object representing the plume flow field has been successfully detected. For example, the definition of the threshold and/or condition(s) for determining whether the first set meets a threshold condition may be different if a wavelet transform or other transform type is employed.

In general, the steps of the method 22 (FIG. 2) may be performed in any order permitted by the internal logic of the method 22. For example, identifying the background image region may be performed at any time prior to or during execution of coding block 34 (FIG. 3), and identifying the plume image region may be performed at any time prior to or during execution of coding block 102 (FIG. 7). Partitioning the second image may be performed at any time prior to or during execution of coding block 70 (FIG. 2), for example. Other examples will become apparent to the person of ordinary skill in the art upon reviewing the disclosure herein.

Thus, there is provided a method of determining a flow rate of a predetermined emissive substance, the method comprising: (a) generating a timed sequence of images; (b) partitioning a first image of the timed sequence into a plurality of blocks of pixels; (c) selecting from the plurality of blocks a selected block having calculated therefrom a first set of Discrete Cosine Transform (DCT) coefficients; (d) determining that the first set meets a condition associated with a predetermined threshold such that the first block represents an intensity pattern of the predetermined emissive substance at a first time; (e) selecting a corresponding block of a second image of the timed sequence, the corresponding block having DCT coefficients correlated to the first set such that the corresponding block represents the intensity pattern at a second time different from the first time; (f) determining a velocity associated with the selected block; and (g) determining the flow rate in response to the velocity.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. A method of determining a flow rate of a predetermined emissive substance, the method comprising:
(a) generating a timed sequence of images;
(b) partitioning a first image of the timed sequence into a plurality of blocks of pixels;
(c) selecting from the plurality of blocks a selected block having calculated therefrom a first set of Discrete Cosine Transform (DCT) coefficients;
(d) determining that the first set meets a condition associated with a predetermined threshold such that the first block represents an intensity pattern of the predetermined emissive substance at a first time;
(e) selecting a corresponding block of a second image of the timed sequence, the corresponding block having DCT coefficients correlated to the first set such that the corresponding block represents the intensity pattern at a second time different from the first time;
(f) determining a velocity associated with the selected block; and
(g) determining the flow rate in response to the velocity.
